(19) United States
(12) Patent Application Publication
(10) Pub. No.: US 2005/0207071 A1
(43) Pub. Date: Sep. 22, 2005

(54) Magnetosensitive device and method of manufacturing the same

(75) Inventors: Masashige Sato, Kawasaki (JP); Hideyuki Kikuchi, Kawasaki (JP); Kazuo Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/076,451

(22) Filed: Mar. 9, 2005

Related U.S. Application Data
(63) Continuation of application No. PCT/JP02/09426, filed on Sep. 13, 2002.

(51) Int. Cl. G11B 5/33; G11B 5/127

(52) U.S. Cl. 360/324.2

(57) ABSTRACT

A magnetosensitive device is disclosed that includes a ferromagnetic tunnel junction formed of two ferromagnetic films and an insulating film sandwiched therebetween. The insulating film is an aluminum nitride film. The barrier height of the ferromagnetic tunnel junction is less than or equal to 0.4 eV.

### CROSS-REFERENCE TO RELATED APPLICATION

This application is a U.S. continuation application filed under 35 U.S.C. 111(a) claiming benefit under 35 U.S.C. 120 and 365(c) of PCT International Application No. PCT/JP2002/009426, filed on Sep. 13, 2002, the entire contents of which are hereby incorporated by reference.

### BACKGROUND OF THE INVENTION

1. Field of the Invention

The present invention relates generally to magnetosensitive devices, and more particularly to a magnetoresistive device having a ferromagnetic tunnel junction and a method of manufacturing the same.

2. Description of the Related Art

A magnetosensitive device is provided in the reproduction head of the magnetic head of a magnetic storage unit, particularly a magnetic disk unit. Conventionally, a spin-valve GMR (giant magnetoresistance) thin film is used for the magnetosensitive device, while studies have been conducted of a TMR (tunneling magnetoresistance) thin film having a ferromagnetic tunnel junction in order to further increase the magnetoresistive effect.

When a voltage is applied across a multilayer body having a metal film/insulating film/metal film junction, current flows despite the insulating film if the insulating film is a few nanometers or less in thickness. This is because the probability of electrons passing through an energy barrier is not zero due to quantum mechanical effects. This current and junction are called tunnel current and tunnel junction, respectively.

Normally, a metal oxide film is used for the insulating film. For instance, the surface layer of aluminum is oxidized by natural oxidation, plasma oxidation, or thermal oxidation. By these methods and their conditions, an aluminum oxide film of a few nanometers or less in thickness can be formed on the surface, and can be used as the insulating film of this junction. The tunnel junction, whose I-V characteristic is not ohmic but rather shows non-linearity, has been used as a non-linear device.

By replacing the metal films of the tunnel junction with ferromagnetic films, a ferromagnetic tunnel junction can be formed. It is known that the tunnel resistance of the ferromagnetic tunnel junction depends on the state of magnetization of the ferromagnetic films on both sides. That is, it is possible to control the tunnel resistance by an externally applied magnetic field. The tunnel resistance R is given as follows:
R=Rs+0.5ΔR(1−cos θ),
where θ is the relative angle of magnetization of each ferromagnetic film. That is, when the orientation of magnetization is parallel (θ=0°), the tunnel resistance R is minimized, and when the orientation of magnetization is anti-parallel (θ=180°), the tunnel resistance R is maximized (R=Rs+ΔR).

This results from the polarization of electrons inside the ferromagnetic films. For instance, electrons having upward spin and electrons having downward spin are equal in number inside non-magnetic metal. Accordingly, the non-magnetic metal shows non-magnetism as a whole. On the other hand, the number of electrons having upward spin Nᵤₚ is different from the number of electrons having downward spin N_{down} inside magnetic metal. Accordingly, the magnetic metal has upward or downward magnetization as a whole. It is known that when an electron tunnels through an insulating film, the orientation of its spin is preserved. Accordingly, if there is no room in the state of electrons ahead of the insulating film, that is, ahead of the tunnel, it is impossible to perform tunneling.

A tunneling magnetoresistance ratio (hereinafter also referred to as “TMR ratio”) AR/R is given by:
ΔR/R=2P₁×P₂/(1−P₁×P₂),
where P₁ is the polarization rate of an electron source (one of the ferromagnetic films) and P₂ is the polarization rate of a tunneling destination (the other one of the ferromagnetic films) with P₁ and P₂ being given as:
P₁,P₂=2(Nᵤₚ−N_{down})/(Nᵤₚ+N_{down})
Each of P₁ and P₂ depends on the type and the composition of the ferromagnetic film. For instance, the polarization rates of NiFe, Co, and CoFe are 0.3, 0.34, and 0.46, respectively. In this case, theoretically, the TMR ratios are approximately 20%, 26%, and 54%, respectively. Thus, higher TMR ratios can be expected than in the case of the conventional anisotropic magnetoresistance (AMR) or GMR.

Meanwhile, in terms of detecting the electric potential difference of the ferromagnetic tunnel junction by causing current to flow therethrough, it is preferable that the tunnel resistance R be reduced in magnitude. It is known that the tunnel resistance R depends on the insulating barrier height φ and the insulating barrier width d of the insulating film. That is, the tunnel resistance R is given by:
R=exp(d×φ^{1/2}),
and the insulating film is desired to be low in the insulating barrier height φ and narrow in the insulating barrier width d.

Conventionally, it is proposed to mainly use an aluminum oxide film for the insulating film. However, it is difficult to put the aluminum oxide film into practical use because the tunnel resistance R is high for use in a magnetic sensor, particularly, a magnetic head for ultra high-density recording of, for instance, 100 Gbit/in² or higher. On the other hand, it has been studied to reduce the tunnel resistance R by using an aluminum nitride film instead of the aluminum oxide film. According to Sun, J. J., and R. C. Sousa; J. Magn. Soc. Japan, 23, 55 (1999), aluminum is formed into a film by reactive sputtering in an argon gas atmosphere including nitrogen, thereby forming an aluminum nitride film. However, a ferromagnetic tunnel junction of a high TMR ratio is not obtained.

### SUMMARY OF THE INVENTION

Accordingly, it is a general object of the present invention to provide a magnetosensitive device in which the above-described disadvantages are eliminated.

A more specific object of the present invention is to provide a magnetosensitive device having a ferromagnetic tunnel junction that is high in the tunneling magnetoresistance ratio and low in tunnel resistance.

The above objects of the present invention are achieved by a magnetosensitive device including a ferromagnetic tunnel junction formed of two ferromagnetic films and an insulating film sandwiched therebetween, the insulating film being an aluminum nitride film, wherein a barrier height of the ferromagnetic tunnel junction is less than or equal to 0.4 eV.

According to the above-described magnetosensitive device, it is possible to reduce tunnel resistance and increase the tunneling magnetoresistance ratio by employing an aluminum nitride film as the insulating film of a ferromagnetic tunnel junction that detects an external magnetic field in a magnetosensitive device, and making the barrier height of the ferromagnetic tunnel junction less than or equal to 0.4 eV. As a result, it is possible to realize a highly sensitive magnetosensitive device.

The above objects of the present invention are also achieved by a magnetosensitive device including two ferromagnetic tunnel junctions formed of a first antiferromagnetic film, a first ferromagnetic film, a first insulating film, a second ferromagnetic film, a second insulating film, a third ferromagnetic film, and a second antiferromagnetic film stacked in order described, wherein at least one of the first and second insulating films is an aluminum nitride film; and a barrier height of one of the ferromagnetic tunnel junctions which one has the aluminum nitride film is less than or equal to 0.4 eV.

According to the above-described magnetosensitive device, the magnetosensitive device includes a dual ferromagnetic tunnel junction with the direction of magnetization of the first ferromagnetic film and that of the third ferromagnetic film being fixed by the adjacent first and second antiferromagnetic films, respectively. Accordingly, it is possible to further increase the tunneling magnetoresistance ratio by the dual ferromagnetic tunnel junction. Further, since the ferromagnetic tunnel junctions are disposed symmetrically, it is possible to stabilize a switching magnetic field where the magnetization of the second ferromagnetic film turns in accordance with an external magnetic field. Further, the insulating film of at least one of the two ferromagnetic tunnel junctions is formed of an aluminum nitride film, and the barrier height of the one of the ferromagnetic tunnel junctions is made less than or equal to 0.4 eV. Thereby, it is possible to reduce tunnel resistance and increase the tunneling magnetoresistance ratio. As a result, it is possible to provide a magnetosensitive device of higher sensitivity with a stable switching magnetic field.

The above objects of the present invention are also achieved by a method of manufacturing a magnetosensitive device, the magnetosensitive device including a ferromagnetic tunnel junction formed of a first ferromagnetic film, an insulating film, and a second ferromagnetic film stacked in order described, the insulating film being an aluminum nitride film, the method including the steps of: (a) depositing an aluminum film on the first ferromagnetic film; and (b) converting the aluminum film into an aluminum nitride film by forming a plasma in a gas including nitrogen.

The above objects of the present invention are also achieved by a method of manufacturing a magnetosensitive device, the magnetosensitive device including a ferromagnetic tunnel junction formed of a first ferromagnetic film, an insulating film, and a second ferromagnetic film stacked in order described, the insulating film being an aluminum nitride film, the method including the steps of: (a) depositing an aluminum film on the first ferromagnetic film; and (b) converting the aluminum film into an aluminum nitride film by exposing the aluminum film to nitrogen radicals N* formed by forming a plasma in a gas including nitrogen.

According to the above-described methods, an aluminum nitride film that is the insulating film of a ferromagnetic tunnel junction is formed by forming a plasma in a gas including nitride and causing nitriding reactions by bringing generated nitrogen ions or nitrogen radicals N* into contact with an aluminum film formed on the first ferromagnetic film. It is preferable to minimize the energy of entrance of the nitrogen ions into the aluminum film as much as possible. It is further preferable to particularly employ only the nitrogen radicals N* that are carried by the flow of nitrogen gas inside a vacuum chamber to reach the surface of the aluminum film. In this case, it is possible to form the aluminum nitride film without damaging the film quality of the aluminum film. Further, it is also possible to prevent the entrance of excessive nitrogen. Accordingly, it is possible to maintain the compactness of aluminum nitride. As a result, it is possible to obtain an aluminum nitride film of excellent quality. Therefore, it is possible to realize a magnetosensitive device having a ferromagnetic tunnel junction that is high in the tunneling magnetoresistance ratio and low in tunnel resistance.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram showing a magnetosensitive device according to a first embodiment of the present invention;

FIG. 2 is a schematic diagram showing a configuration of a microwave radical gun that performs radical processing according to the first embodiment of the present invention;

FIG. 3 is a schematic diagram showing a magnetosensitive device according to a first variation of the first embodiment of the present invention;

FIG. 4 is a schematic diagram showing a magnetosensitive device according to a second variation of the first embodiment of the present invention;

FIG. 5A is a plan view of a four-terminal circuit configured to measure the I-V characteristic of a magnetosensitive device according to an example implementation according to the first embodiment of the present invention;

FIG. 5B is a sectional view of the magnetosensitive device according to the example implementation according to the first embodiment of the present invention;

FIG. 6 is a graph illustrating the relationship between TMR ratio and an RA value according to the first embodiment of the present invention;

FIG. 7 is a graph illustrating an I-V characteristic according to the first embodiment of the present invention;

FIG. 8A is a graph illustrating the relationship between an insulating barrier width d and the RA value according to the first embodiment of the present invention;

FIG. 8B is a graph illustrating the relationship between an insulating barrier height φ and the RA value according to the first embodiment of the present invention;

FIG. 9 is a sectional view of part of a magnetic storage unit according to a second embodiment of the present invention;

FIG. 10 is a plan view of the part of the magnetic storage unit of FIG. 9 according to the second embodiment of the present invention;

FIG. 11 is an enlarged perspective view of part of a recording and reproduction head illustrated in FIG. 10 according to the second embodiment of the present invention;

FIG. 12 is a diagram showing a configuration of a face of the reproduction magnetic head which face opposes a corresponding magnetic recording medium according to the second embodiment of the present invention;

FIG. 13 is a schematic diagram showing a magnetic memory according to a third embodiment of the present invention; and

FIG. 14 is a schematic diagram showing a contactless rotary switch according to a fourth embodiment of the present invention.

### DETAILED DESCRIPTION OF THE PREFERRED EMBODIMENTS

A description is given below, with reference to the accompanying drawings, of embodiments of the present invention.

### First Embodiment

First, a description is given of a magnetosensitive device according to the present invention.

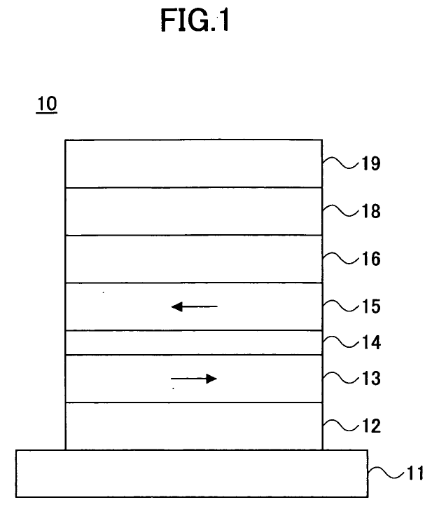

FIG. 1 is a schematic diagram showing a magnetosensitive device 10 according to a first embodiment of the present invention. Referring to FIG. 1, the magnetosensitive device 10 has the structure of a lower electrode 12, a first ferromagnetic film 13, an insulating film 14, a second ferromagnetic film 15, an antiferromagnetic film 16, an antioxidation film 18, and an upper electrode 19 being stacked on a substrate 11 in the order described. In this configuration, the first ferromagnetic film 13, the insulating film 14, and the second ferromagnetic film 15 form a ferromagnetic tunnel junction. The magnetization of the second ferromagnetic film 15 is fixed using the unidirectional anisotropy of the interface with the adjacent antiferromagnetic film 16. Accordingly, the direction of magnetization of the first ferromagnetic film 13, which is a free layer, changes relative to the second ferromagnetic film 15, which is a magnetization fixation layer, in accordance with an externally applied magnetic field, so that tunnel resistance changes based on the relative angle of the two magnetizations.

An insulator such as a ceramic of Al₂O₃ and TiC or a semiconductor such as a Si wafer can be used as the substrate 11. The material of the substrate 11 is not limited in particular. The substrate 11 preferably has good flatness in terms of uniform formation of each thin film forming the ferromagnetic tunnel junction stacked on the substrate 11. The lower electrode 12 is formed of, for instance, Ta, Cu, Au, or a multilayer body of any combination of these elements, of 5 nm to 40 nm in thickness.

The first ferromagnetic film 13 is formed of, for instance, a soft ferromagnetic material including any of Co, Fe, Ni, and combinations of these elements, such as Ni₈₀Fe₂₀ or CO₇₅Fe₂₅, or a multilayer body of any combination of these films, of 1 nm to 30 nm in thickness. The magnetization of the first ferromagnetic film 13 exists in the film plane, and its orientation changes in accordance with the direction of an external magnetic field.

The insulating film 14 is formed of aluminum nitride of 0.5 nm to 2.0 nm, preferably 0.7 nm to 1.2 nm, in thickness. This aluminum nitride film is formed by converting an aluminum film, formed by vapor deposition or sputtering, by nitriding according to a below-described manufacturing method. Expressing the composition of the aluminum nitride film as Al_{1-X}N_{X}, a compound composition X is preferably 40 at. % to 60 at. % in terms of providing the aluminum nitride film with a good insulating property, and stability to prevent nitrogen diffusion. An aluminum nitride film of such a composition can be formed by nitriding.

The second ferromagnetic film 15 is formed of, for instance, a soft ferromagnetic material including any of Co, Fe, Ni, and combinations of these elements, such as Ni₈₀Fe₂₀ or CO₇₅Fe₂₅, or a multilayer body of any combination of these films, of 1 nm to 30 nm in thickness. The second ferromagnetic film 15 may be different in composition from the first ferromagnetic film 13.

The direction of magnetization of the second ferromagnetic film 15 is fixed by the exchange interaction with the antiferromagnetic film 16 described below. That is, application of an external magnetic field does not change the direction of magnetization of the second ferromagnetic film 15. As a result, only the magnetization of the above-described first ferromagnetic film 13 changes its orientation in accordance with an external magnetic field. In consequence, the tunneling magnetoresistance ratio changes based on the relative angle of the magnetization of the first ferromagnetic film 13 with respect to the magnetization of the second ferromagnetic film 15.

The antiferromagnetic film 16 is formed of, for instance, an antiferromagnetic layer of 5 nm to 30 nm in thickness, the antiferromagnetic layer including Mn and at least one element selected from a group of Re, Ru, Rh, Pd, Ir, Pt, Cr, Fe, Ni, Cu, Ag, and Au. The Mn content thereof is preferably 45 at. % to 95 at. %. The antiferromagnetism of the antiferromagnetic film 16 appears by heat treatment in a predetermined magnetic field.

The antioxidation film 18 is formed of, for instance, non-magnetic metal such as Au, Ta, Al, or W of 5 nm to 30 nm in thickness. The antioxidation film 18 is provided in order to prevent oxidation of the multilayer body in the heat treatment of the antiferromagnetic film 16. Like the lower electrode 12, the upper electrode 19 is formed of a non-magnetic material having good conductivity.

The magnetosensitive device 10 according to this embodiment employs the insulating film 14, which is an aluminum nitride film to which an aluminum film is converted by nitriding, particularly with nitrogen radicals N*. A description is given below of a method of manufacturing the magnetosensitive device 10 according to this embodiment, focusing on this nitriding.

Each of the films forming the magnetosensitive device 10 except the insulating film 14 is formed by sputtering, plating, or vacuum deposition.

First, the lower electrode 12 and the first ferromagnetic film 13 are formed in the order described on the substrate 11. Thereafter, an aluminum film of 0.5 nm to 1.5 nm in thickness is formed on this multilayer body by sputtering or vacuum deposition.

Next, the aluminum is subjected to nitriding by natural nitriding, radical nitriding, or plasma nitriding. According to natural nitriding, the aluminum film is exposed to nitrogen by introducing the nitrogen into a process chamber so as to cause a nitriding reaction to occur at the surface of the aluminum film. Natural nitriding is preferable in that the nitriding reaction progresses evenly over the entire aluminum film or the entire substrate. However, the process time of nitriding is long because the nitriding reaction is slow compared with other methods.

Meanwhile, according to plasma nitriding, nitrogen is ionized or changed to an atomic state (radicals) by forming a plasma in a process chamber, so that nitrogen ions and nitrogen radicals N* enter the aluminum film through its surface and react therewith so as to convert the aluminum film into an aluminum nitride film. Plasma nitriding is preferable in that the process time of nitriding can be shortened because the nitride ions, which are accelerated to collide with the aluminum film, are more reactive. However, providing the nitrogen ions with excessive acceleration energy may damage the aluminum film, thus degrading the surface characteristic and the crystallinity of the aluminum surface. Further, there is even concern that pin holes may be formed.

On the other hand, according to radical nitriding, only nitride radicals N* react with the aluminum film without being accelerated. Accordingly, no damage is caused to the aluminum film when the nitrogen radicals N* come into contact with the aluminum film. Thus, radical nitriding is preferable in that the aluminum film can be converted into an aluminum nitride film without damage to the crystallinity of the aluminum film.

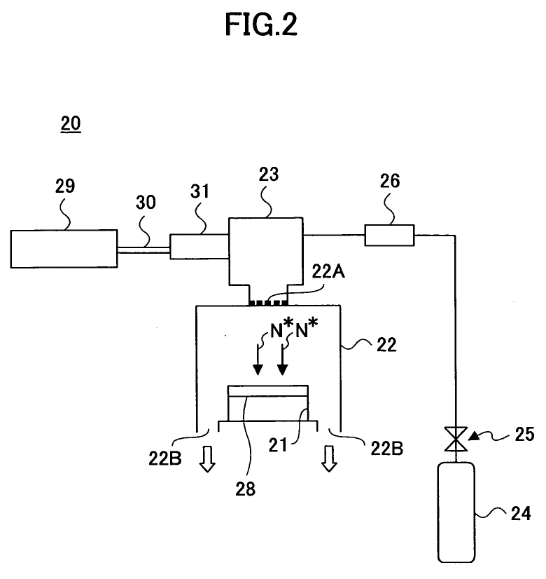

FIG. 2 is a schematic diagram showing a configuration of a microwave radical gun 20 that performs radical processing. Referring to FIG. 2, the microwave radical gun 20 includes a vacuum chamber 22 having a sample table 21 holding a substrate to be processed. The vacuum chamber 22 is evacuated, and N₂ gas is introduced from a nitrogen cylinder 24 through a valve 25 and a flow controller 26 into a discharge tube 23 formed on part of the wall face of the vacuum chamber 22. Thereby, the pressure inside the vacuum chamber 22 is set to approximately 0.8 Pa, and the rate of flow is set to approximately 30 sccm. Further, a substrate 28 on which the magnetosensitive device 10 is to be formed is placed on the sample table 21, and the temperature of the substrate 28 is set to 25° C. The temperature is preferably set within the range of 10° C. to 40° C. The results described below are substantially the same as long as the temperature is set within this range.

Next, a microwave of 2.4 GHz is introduced into the discharge tube 23 through a matching unit 31 from a coaxial waveguide 30 connected to an external microwave power supply 29, so that a high-density plasma is generated inside the discharge tube 23. The distance between the substrate 28 and a connection part 22A of the discharge tube 23 and the vacuum chamber 22 is set to approximately 30 cm.

The input power of the discharge tube 23 is set to 100 W to 200 W, and process time is set to approximately 200 seconds. Nitrogen radicals N* generated inside the discharge tube 23 enter the vacuum chamber 22 from the discharge tube 23, being carried by the flow of nitrogen gas, which is discharged from an outlet 22B at the other end of the vacuum chamber 22. The nitrogen radicals N* entering the vacuum chamber 22 come into contact with the surface of the aluminum film of the substrate 28 so as to convert the aluminum film into an aluminum nitride film. The process time, which is approximately several hundreds of seconds, is appropriately selected in relation to the input power.

The microwave radical gun 20 is described above as an example. Alternatively, a helicon wave or high-frequency plasma generator may be employed. In this case, it is possible to employ only nitrogen radicals N* by removing nitrogen ions using an ion filter.

Next, the second ferromagnetic film 15, the antiferromagnetic film 16, the antioxidation film 18, and the upper electrode 19 are formed in the order described on the aluminum nitride film. Next, in order to cause the antiferromagnetism of the antiferromagnetic film 16 to appear, a magnetic field of approximately 118.5 kA/m (1500 Oe) is applied in a predetermined direction, and heat treatment is performed at approximately 250° C. for 180 minutes. As a result, the magnetosensitive device 10 of this embodiment illustrated in FIG. 1 is formed.

According to this embodiment, as described above, an aluminum film is converted by nitriding into an aluminum nitride film as the insulating film 14 forming a ferromagnetic tunnel junction. In particular, the nitriding is performed using nitrogen radicals N*. Accordingly, the aluminum film is prevented from being damaged. Therefore, an aluminum nitride film having good film quality and a uniform interface between the insulating film 14 and the second ferromagnetic film 15 can be obtained.

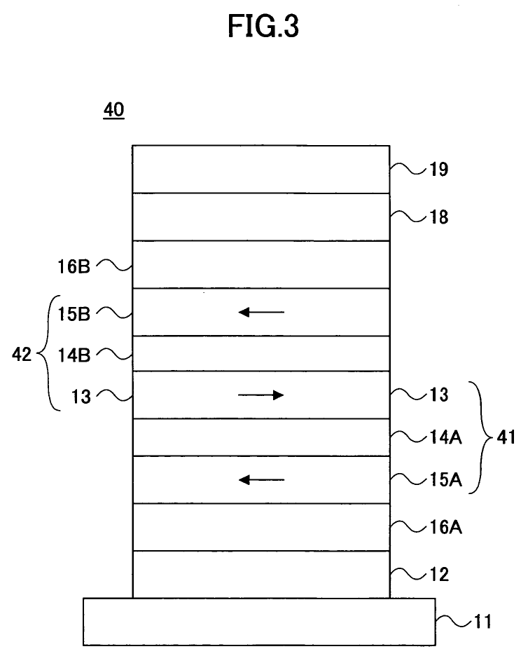

FIG. 3 is a schematic diagram showing a magnetosensitive device 40 according to a first variation of the first embodiment. In FIG. 3, the same elements as those described in FIG. 1 are referred to by the same numerals, and a description thereof is omitted.

Referring to FIG. 3, the magnetosensitive device 40 of this variation includes a dual ferromagnetic tunnel junction. That is, the magnetosensitive device 40 has the structure of the lower electrode 12, an antiferromagnetic film 16A, a second ferromagnetic film 15A, an insulating film 14A, the first ferromagnetic film 13, an insulating film 14B, a second ferromagnetic film 15B, an antiferromagnetic film 16B, the antioxidation film 18, and the upper electrode 19 being stacked on the substrate 11 in the order described. In this configuration, the second ferromagnetic film 15A, the insulating film 14A, and the first ferromagnetic film 13 form a first ferromagnetic tunnel junction 41, and the first ferromagnetic film 13, the insulating film 14B, and the second ferromagnetic film 15B form a second ferromagnetic tunnel junction 42. The magnetization of the second ferromagnetic film 15A and the magnetization of the second ferromagnetic film 15B are fixed in the same direction by the adjacent antiferromagnetic films 16A and 16B, respectively. Accordingly, according to this variation, when the magnetization of the first ferromagnetic film 13, which is a free layer, changes its direction in accordance with an external magnetic field, the relative angle of the magnetization of the first ferromagnetic film 13 is the same with respect to the second ferromagnetic films 15A and 15B. Accordingly, the tunnel resistance of the first ferromagnetic tunnel junction 41 and the tunnel resistance of the second ferromagnetic tunnel junction 42 change in the same manner. Therefore, the TMR ratio is doubled, so that a magnetosensitive device of higher sensitivity can be realized.

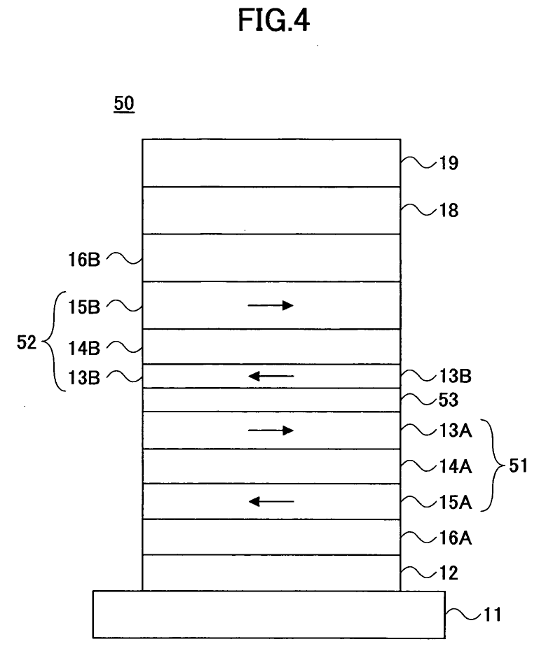

FIG. 4 is a schematic diagram showing a magnetosensitive device 50 according to a second variation of this embodiment. In FIG. 4, the same elements as those described in FIGS. 1 and 3 are referred to by the same numerals, and a description thereof is omitted.

Referring to FIG. 4, the magnetosensitive device 50 according to this variation has the same configuration as the magnetosensitive device 40 of the first variation except that the first ferromagnetic film 13 of the first variation is replaced with two ferromagnetic films 13A and 13B, which are coupled antiferromagnetically through a thin-layer non-magnetic film 53. That is, the lower ferromagnetic film 13A, the non-magnetic film 53, and the upper ferromagnetic film 13B are stacked in the order described, and the lower and upper ferromagnetic films 13A and 13B are equalized in the magnetic material composition. Further, the lower ferromagnetic film 13A is formed to have a greater film thickness than the upper ferromagnetic film 13B. The lower and upper ferromagnetic films 13A and 13B may employ the same material as the above-described first ferromagnetic film 13 of 1-30 nm in thickness. The non-magnetic film 53 is formed of, for instance, Ru, Cr, a Ru alloy, or a Cr alloy of 0.4 nm to 2 nm in thickness. The configuration of the lower ferromagnetic film 13A/the non-magnetic film 53/the upper ferromagnetic film 13B is, for instance, CO₇₅Fe₂₅ (20 nm)/Ru (0.8 nm)/CO₇₅Fe₂₅ (12 nm) According to this configuration, the magnetization of the lower ferromagnetic film 13A changes its direction in accordance with an external magnetic field, so that the magnetization of the upper ferromagnetic film 13B, which is coupled antiferromagnetically to the magnetization of the lower ferromagnetic film 13A, is oriented in the direction opposite to that of the magnetization of the lower ferromagnetic film 13A. The antiferromagnetic films 16A and 16B adjacent to the second ferromagnetic films 15A and 15B, respectively, whose magnetization is to be fixed, are set so that the magnetization of the second ferromagnetic film 15A and the magnetization of the second ferromagnetic film 15B are fixed in the opposite directions. According to this variation, the TMR ratio is doubled by first and second ferromagnetic tunnel junctions 51 and 52, and the lower ferromagnetic film 13A, the non-magnetic film 53, and the upper ferromagnetic film 13B, which form a free layer, can improve the switching characteristic of the magnetization of the lower and upper ferromagnetic films 13A and 13B.

[Example Implementation]

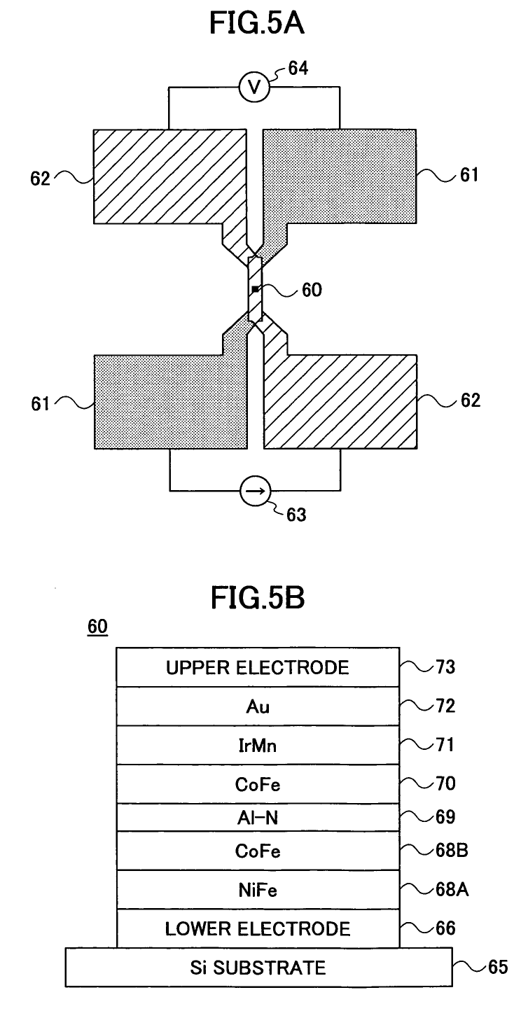

FIG. 5A is a plan view of a four-terminal circuit configured to measure the I-V characteristic of a magnetosensitive device 60 (FIG. 5B) according to this example implementation. FIG. 5B is a sectional view of the magnetosensitive device 60 according to this example implementation. Referring to FIG. 5A, two pairs of a lower electrode 61 and an upper electrode 62 were extended from the magnetosensitive device 60, which was so small as to be indicated as a dot in the drawing. A current source 63 for causing current to flow was connected to the lower and upper electrodes 61 and 62 of one of the pairs, and a digital voltmeter 64 for detecting a voltage V was connected to the other pair, so that the I-V characteristic was measured. Referring to FIG. 5B, after formation up to an antioxidation film, the multilayer body of the magnetosensitive device 60 was cut down to several square micrometers (μm²) or less in the junction area by photolithography or ion etching, and was isolated by a silicon oxide film (not graphically illustrated). A specific description is given below.

Referring to FIG. 5B, a multilayer body of Ta (25 nm), Au (30 nm), and Ta (5 nm) was formed as a lower electrode 66 on a Si substrate 65. Next, Ni₇₅Fe₂₅ of 4 nm and CO₇₄Fe₂₆ of 3 nm were formed as first ferromagnetic films 68A and 68B, respectively. Next, an aluminum film was formed to have a thickness of 0.5 nm to 1.5 nm, and was converted into an aluminum nitride film 69 by nitriding using the above-described microwave radical gun 20 (FIG. 2) with input power being set to 100 W, pressure inside the vacuum chamber 22 being set to 0.8 Pa, rate of flow of nitrogen gas being set to 30 sccm, and process time being set to 120-250 seconds. As a second ferromagnetic film 70, CO₇₄Fe₂₆ of 2.5 nm in thickness was formed. As an antiferromagnetic layer 71, IrMn of 15 nm in thickness was formed. Next, as an antioxidation film 72, Au of 20 nm in thickness was formed. Next, this multilayer body was ground down to several 1 μm² in the junction area by photolithography or ion milling. Then, a silicon oxide film (not graphically illustrated) was formed for insulation. Next, an upper electrode 73 was formed.

[Evaluation]

The tunnel resistance R of the magnetosensitive device 60 of the example implementation was measured, and a TMR ratio and an RA value were obtained. The tunnel resistance R was measured as follows. A current of such a value as to make 50 mV the voltage between the lower and upper electrodes 66 and 73 of the magnetosensitive device 60 was applied in the state of parallel magnetization, and the voltage between the lower and upper electrodes 66 and 73 was detected. An external magnetic field was set to −39.5 kA/m (−500 Oe) to 39.5 kA/m (500 Oe) in magnitude, and was applied in parallel with the direction of the magnetization of the second ferromagnetic film 70, which was fixed in the film plane by the antiferromagnetic film 71. Then, the tunnel resistance R was measured. The TMR ratio was given by:
TMR ratio (%)(Rₘₐₓ−Rₘᵢₙ)/Rₘᵢₙ×100,
where Rₘₐₓ is the maximum value of the tunnel resistance R, and Rₘᵢₙ is the minimum value of the tunnel resistance R. The RA value was given by multiplying Rₘᵢₙ and the junction area A of the ferromagnetic tunnel junction.

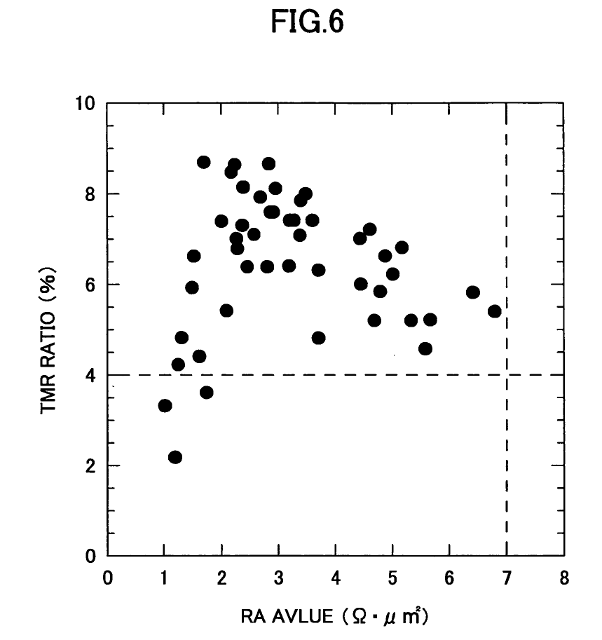

FIG. 6 is a graph illustrating the relationship between the TMR ratio and the RA value. FIG. 6 shows that the TMR ratio is maximized within the range of RA values of 2-5 Ω·μm². Further, FIG. 6 also shows that while the TMR ratio decreases in the range of RA values greater than 5 Ω·μm², the TMR ratio is approximately 4% at the RA value of 7 Ω·μm², which is better than the above-described conventional ferromagnetic tunnel junction in which the aluminum nitride film is formed by reactive sputtering. The TMR ratio further decreases in the range of RA values greater than 7 Ω·μm². It is inferred that this is because the aluminum film, which is to serve as an insulating film, is not completely nitrided in the direction of its thickness.

Next, the I-V characteristic of the magnetosensitive device 60 of the example implementation was measured, and the insulating barrier height φ and the insulating barrier width d of the insulating film were obtained by numerical calculations using the following equations (1) through (4).

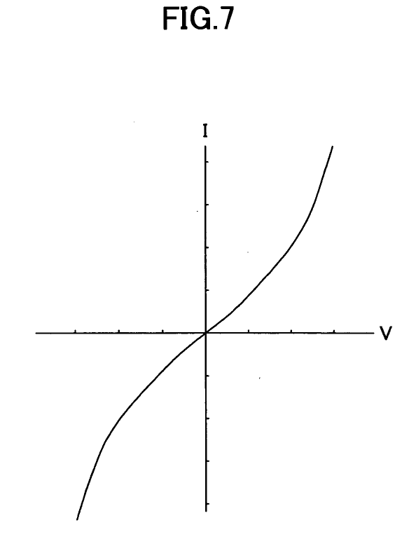

FIG. 7 is a graph illustrating an I-V characteristic. As illustrated in FIG. 7, Current I changes linearly around V=0, but is proportional to V³ as it is away from V=0. Accordingly, the I-V characteristic can be expressed as follows:
I(φ)=θ(V+γV³), (1)
θ=(αβφ^{1/2}/d)×exp(−αd^{1/2}) (2)
γ=(αd)²/(96φ)−(αde²/32)×φ^{-3/2}, (3)
α=4π(2m)^{1/2}/h, β=e²/4πh, (4)
where V is applied voltage, and h, m, and e are Planck's constant, mass of electrons, and an electric charge, respectively.

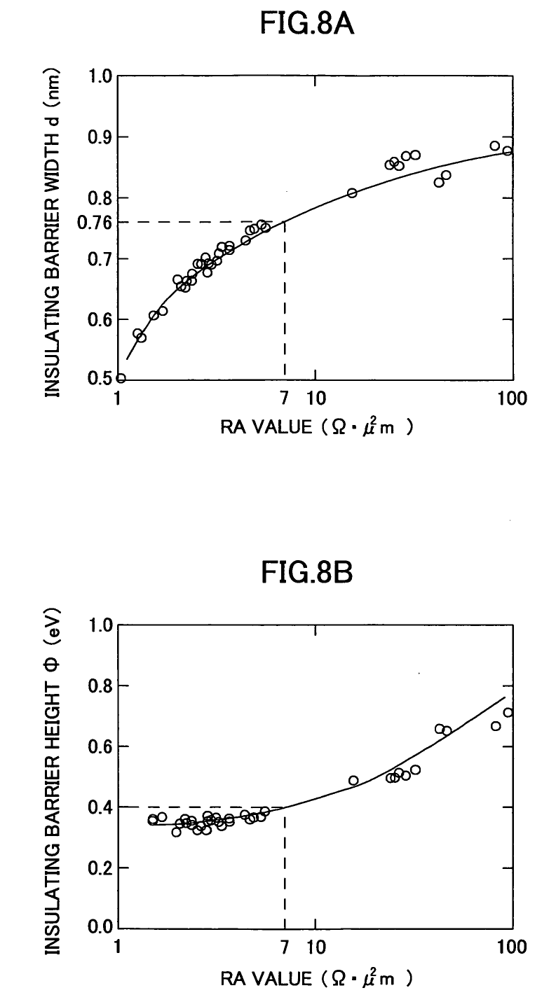

FIG. 8A is a graph illustrating the relationship between the insulating barrier width d and the RA value, and FIG. 8B is a graph illustrating the relationship between the insulating barrier height φ and the RA value.

According to the relationship between the insulating barrier width d and the RA value illustrated in FIG. 8A, the insulating barrier width d shows a tendency to decrease as the RA value decreases. FIG. 8A shows that the insulating barrier width d is less than or equal to 0.76 nm when the RA value is less than or equal to 7 Ω·μm².

As illustrated in FIG. 8B, the insulating barrier height φ also shows a tendency to decrease as the RA value decreases. In particular, FIG. 8B shows that the insulating barrier height φ is less than or equal to 0.4 eV when the RA value is less than or equal to 7 Ω·μm². The above-described ferromagnetic tunnel junction in which the aluminum nitride film is formed by reactive sputtering has an insulating barrier height φ of approximately 0.6 eV. Accordingly, an aluminum nitride film formed by nitriding with nitrogen radicals N* according to the present invention is suitable as the insulating film of a ferromagnetic tunnel junction.

FIGS. 6 through 8B show that with respect to an aluminum nitride film formed by nitriding with nitrogen radicals N*, it is possible to reduce the RA value of a ferromagnetic tunnel junction to or below 7 Ω·μm² by making the insulating barrier width d less than or equal to 0.76 nm or making the insulating barrier height φ less than or equal to 0.4 eV. Further, it is also possible to make the TMR ratio higher than or equal to 4%. The less the insulating barrier height φ is, the better. However, the insulating barrier height φ is preferably greater than or equal to 0.2 eV since the tunnel resistance decreases and the TMR ratio also decreases if the insulating barrier height φ is excessively small.

Accordingly, according to this example implementation, it is possible to increase the TMR ratio and reduce the RA value by using, as the insulating film of a ferromagnetic tunnel junction, an aluminum nitride film into which an aluminum film is converted by nitriding with nitrogen radicals N*. That is, it is possible to realize a magnetosensitive device that is highly sensitive and operable at high speed.

### Second Embodiment

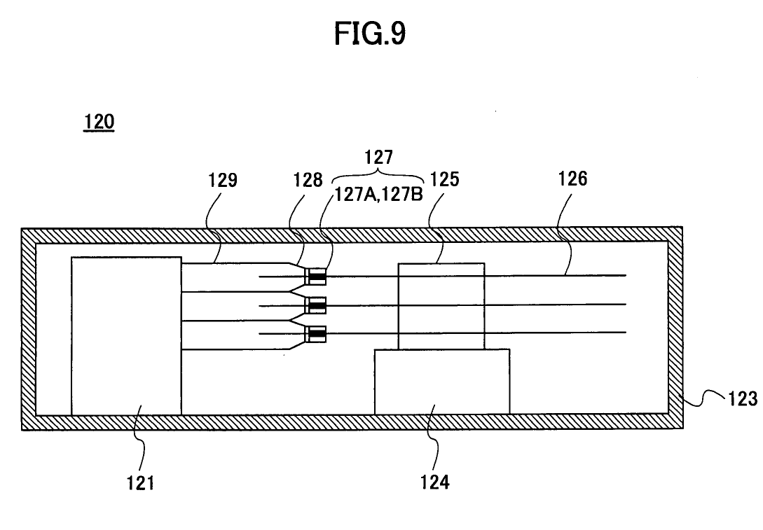

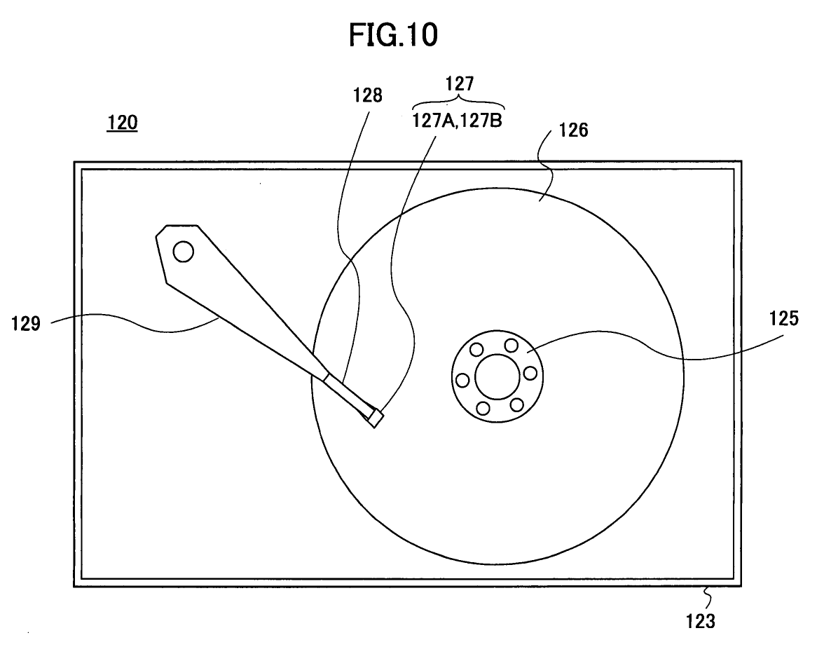

Next, a description is given, with reference to FIGS. 9 and 10, of a magnetic storage unit according to a second embodiment of the present invention. FIG. 9 is a sectional view of part of a magnetic storage unit 120 according to the second embodiment of the present invention. FIG. 10 is a plan view of the part of the magnetic storage unit 120 illustrated in FIG. 9.

Referring to FIGS. 9 and 10, the magnetic storage unit 120 includes a housing 123. Inside the housing 123, the magnetic storage unit 120 includes a motor 124, a hub 125, multiple magnetic recording media 126, multiple recording and reproduction heads 127, multiple suspensions 128, multiple arms 129, and an actuator unit 121. The magnetic recording media 126 are attached to the hub 125 rotated by the motor 124. Each recording and reproduction head 127 is a composite-type head, including an induction-type recording magnetic head 127A and a reproduction magnetic head 127B using a magnetosensitive device having a ferromagnetic tunnel junction. Each recording and reproduction head 127 is attached to the end of the corresponding arm 129 through the corresponding suspension 128. The arms 129 are driven by the actuator unit 121. The basic configuration of this magnetic storage unit 120 is well known, and a detailed description thereof is omitted in this specification.

The magnetic storage unit 120 according to this embodiment is characterized by the reproduction magnetic heads 127B.

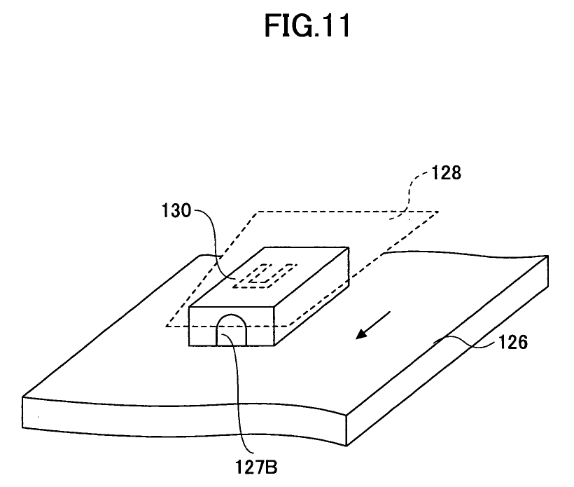

FIG. 11 is an enlarged perspective view of part of one of the recording and reproduction heads 127. Referring to FIG. 11, the reproduction magnetic head 127B is provided to one side of a slider 130 in a direction in which the magnetic recording medium 126 rotates (indicated by the arrow), the slider being supported by the suspension 128. The corresponding induction-type recording magnetic head 127 is not graphically illustrated for convenience of description.

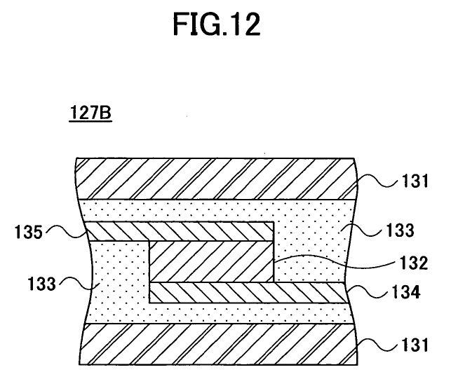

FIG. 12 is a diagram showing a configuration of a face of the reproduction magnetic head 127B, which face opposes the corresponding magnetic recording medium 126. Referring to FIG. 12, the reproduction magnetic head 127B includes two shield films 131, a magnetosensitive device 132 sandwiched between the shield films 131, and an insulating film 133 insulating the shield films 131 and the magnetosensitive device 132 from each other. As the magnetosensitive device 132, for instance, the above-described magnetosensitive device 10, 40, or 50 of the first embodiment illustrated in FIG. 1, 3, or 4 is employed.

In the magnetosensitive device 132, the relative angle of magnetizations forming the ferromagnetic tunnel junction of the magnetosensitive device 132 changes in accordance with a magnetic field leaking from the magnetic recording medium 126, thereby changing tunnel resistance. The information of the magnetic recording medium 126 can be read by detecting voltage determined by current supplied and discharged by a lower electrode 134 and an upper electrode 135 and the tunnel resistance.

According to this embodiment, each recording and reproduction head 127 of the magnetic storage unit 120 includes the magnetosensitive device 132 of high sensitivity. Accordingly, each recording and reproduction head 127 has a high reproduction capability so as to be able to perform reproduction even if a magnetic field leaking from the magnetic reversal region of one magnetic reversal corresponding to one bit of information is reduced significantly, thus being able to support high-density recording.

### Third Embodiment

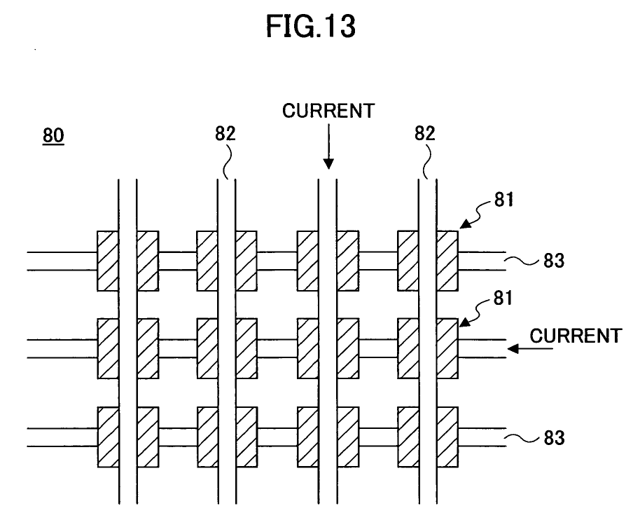

Next, a description is given, with respect to FIG. 13, of a magnetic memory, or a magnetic random access memory (MRAM), according to a third embodiment of the present invention. FIG. 13 is a schematic diagram showing a magnetic memory 80 according to the third embodiment.

Referring to FIG. 13, the magnetic memory 80 includes multiple magnetosensitive devices 81, which are the above-described magnetosensitive devices 10, 40, or 50 of the first embodiment, disposed in a matrix-like manner. The magnetosensitive devices 81 are connected to word lines 82 running in the row direction and bit lines 83 running in the column direction. The word lines 82 are connected to a current source, a switch, and a voltage detector circuit (not graphically illustrated) for causing current to flow through the word lines 82. The bit lines 83 are connected to a current source, a switch, and a voltage detector circuit (not graphically illustrated) for causing current to flow through the bit lines 83.

At the time of writing to the magnetic memory 80, currents are caused to flow simultaneously through the word line 82 and the bit line 83 connected to the magnetosensitive device 81 that is a writing target. The magnetization of the magnetosensitive device 81 is reversed by a magnetic field generated by the currents. The magnetization of the first ferromagnetic film 13 of the first embodiment (FIG. 1), which is a free layer, can store whether a bit is “0” or “1” depending on whether the magnetization of the first ferromagnetic film 13 is parallel or anti-parallel to the magnetization of the second ferromagnetic film 15.

At the time of reading from the magnetic memory 80, current is caused to flow from the bit line 83 connected to the magnetosensitive device 81 that is a reading target to the word line 82 through the magnetosensitive device 81. The state of the magnetosensitive device 81 is either low resistance (when the two magnetizations are parallel) or high resistance (when the two magnetizations are anti-parallel) in accordance with the direction of magnetization of the ferromagnetic tunnel junction of the magnetosensitive device 81. Therefore, the state is read by the voltage across the magnetosensitive device 81. Accordingly, it is possible to determine whether the bit of the magnetosensitive device 81 is “0” or “1.”

According to this embodiment, the magnetosensitive devices 10, 40, or 50 of the first embodiment, which are highly sensitive, are employed. Accordingly, it is possible to reduce write current. Further, since the ferromagnetic tunnel resistance is reduced, it is possible to somewhat increase current to be caused to flow at the time of reading, thus enabling stable reading without hindrance by noise.

### Fourth Embodiment

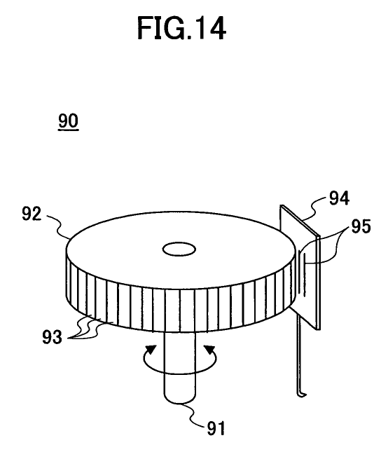

Next, a description is given, with reference to FIG. 14, of a contactless rotary switch, which is an embodiment of an encoder according to the present invention.

FIG. 14 is a schematic diagram showing a contactless rotary switch 90 according to a fourth embodiment of the present invention. Referring to FIG. 14, the contactless rotary switch 90 includes a rotatable shaft 91, a rotary disk 92 joined to the shaft 91, multiple magnetic bodies 93 formed on the peripheral surface of the rotary disk 92, a rotation detection device 94 disposed in proximity to the peripheral surface of the rotary disk 92, and two magnetosensitive devices 95 provided on the rotation detection device 94. As the magnetosensitive devices 95, for instance, the magnetosensitive devices 10, 40, or 50 of the first embodiment illustrated in FIG. 1, 3, or 4 are employed.

The multiple magnetic bodies 93 are disposed at angularly equal intervals so that their magnetizations are oriented in the circumferential directions and each adjacent two of the magnetic bodies 93 have their magnetizations oriented opposite to each other. Accordingly, when the shaft 91 is rotated, magnetic fields leaking from and absorbed into the magnetic bodies 93 are alternately applied to the rotation detection device 94. The two magnetosensitive devices 95 are provided on the rotation detection device 94, being separate from each other in the directions of rotation. The tunnel resistance of each magnetosensitive device 95 changes in accordance with magnetic fields from the magnetic bodies 93. Accordingly, each magnetosensitive device 95 outputs a voltage signal proportional to its tunnel resistance by applied current. The direction of rotation and the rotational speed (rpm) of the shaft 91 are detected from the magnitude and the phase of the voltage signal of each of the two magnetosensitive devices 95.

According to this embodiment, the rotation detection device 94 of the contactless rotary switch 90 includes the highly sensitive magnetosensitive devices 95. Accordingly, the rotation detection device 94 can detect the rotational direction and speed of the shaft 91 and changes therein with accuracy even if the magnetic bodies 93 are reduced in size. Further, since the magnetosensitive devices 95 can be reduced in size, it is possible to provide a compact contactless rotary switch.

The encoder according to the present invention is not limited to a contactless rotary switch, but may be, for instance, a linear encoder.

According to the present invention, it is possible to reduce tunnel resistance and increase the tunneling magnetoresistance ratio by employing an aluminum nitride film as the insulating film of a ferromagnetic tunnel junction that detects an external magnetic field in a magnetosensitive device, and making the barrier height of the ferromagnetic tunnel junction less than or equal to 0.4 eV. As a result, it is possible to realize a highly sensitive magnetosensitive device.

According to the present invention, an aluminum nitride film that is the insulating film of a ferromagnetic tunnel junction is formed by forming a plasma in a gas including nitride and causing nitriding reactions by bringing generated nitrogen ions or nitrogen radicals N* into contact with an aluminum film formed on the first ferromagnetic film. It is preferable to minimize the energy of entrance of the nitrogen ions into the aluminum film as much as possible. It is further preferable to particularly employ only the nitrogen radicals N* that are carried by the flow of nitrogen gas inside a vacuum chamber to reach the surface of the aluminum film. In this case, it is possible to form the aluminum nitride film without damaging the film quality of the aluminum film. Further, it is also possible to prevent the entrance of excessive nitrogen. Accordingly, it is possible to maintain the compactness of aluminum nitride. As a result, it is possible to obtain an aluminum nitride film of excellent quality. Therefore, it is possible to realize a magnetosensitive device having a ferromagnetic tunnel junction that is high in the tunneling magnetoresistance ratio and low in tunnel resistance.

The present invention is not limited to the specifically disclosed embodiments, and variations and modifications may be made without departing from the scope of the present invention.

1. A magnetosensitive device, comprising:
a ferromagnetic tunnel junction formed of two ferromagnetic films and an insulating film sandwiched therebetween, the insulating film being an aluminum nitride film,
wherein a barrier height of the ferromagnetic tunnel junction is less than or equal to 0.4 eV.

2. The magnetosensitive device as claimed in claim 1, wherein the barrier height of the ferromagnetic tunnel junction is greater than or equal to 0.2 eV and less than or equal to 0.4 eV.

3. The magnetosensitive device as claimed in claim 1, wherein a barrier width of the ferromagnetic tunnel junction is less than or equal to 0.76 nm.

4. The magnetosensitive device as claimed in claim 1, wherein a resistance of the ferromagnetic tunnel junction is less than or equal to 7 Ω·μm².

5. The magnetosensitive device as claimed in claim 1, further comprising:
an antiferromagnetic film formed adjacent to one of the two ferromagnetic films so as to be across the one of the two ferromagnetic films from the insulating film,
wherein magnetization of the one of the two ferromagnetic films is fixed by interaction between the one of the two ferromagnetic films and the antiferromagnetic film.

6. The magnetosensitive device as claimed in claim 1, wherein the aluminum nitride film is formed by performing nitriding on an aluminum film by exposing the aluminum film to nitrogen radicals N*.

7. The magnetosensitive device as claimed in claim 1, wherein the aluminum nitride film contains nitrogen of 40 at. % to 60 at. %.

8. A magnetosensitive device, comprising:
two ferromagnetic tunnel junctions formed of a first antiferromagnetic film, a first ferromagnetic film, a first insulating film, a second ferromagnetic film, a second insulating film, a third ferromagnetic film, and a second antiferromagnetic film stacked in order described,
wherein at least one of the first and second insulating films is an aluminum nitride film; and
a barrier height of one of the ferromagnetic tunnel junctions which one has the aluminum nitride film is less than or equal to 0.4 eV.

9. The magnetosensitive device as claimed in claim 8, wherein the second ferromagnetic film is a multilayer body formed of two ferromagnetic films and a non-magnetic film sandwiched therebetween, the two ferromagnetic films being coupled antiferromagnetically.

10. A method of manufacturing a magnetosensitive device, the magnetosensitive device including a ferromagnetic tunnel junction formed of a first ferromagnetic film, an insulating film, and a second ferromagnetic film stacked in order described, the insulating film being an aluminum nitride film, the method comprising the steps of:
(a) depositing an aluminum film on the first ferromagnetic film; and
(b) converting the aluminum film into an aluminum nitride film by forming a plasma in a gas including nitrogen.

11. A method of manufacturing a magnetosensitive device, the magnetosensitive device including a ferromagnetic tunnel junction formed of a first ferromagnetic film, an insulating film, and a second ferromagnetic film stacked in order described, the insulating film being an aluminum nitride film, the method comprising the steps of:
(a) depositing an aluminum film on the first ferromagnetic film; and
(b) converting the aluminum film into an aluminum nitride film by exposing the aluminum film to nitrogen radicals N* formed by forming a plasma in a gas including nitrogen.

12. The method as claimed in claim 11, wherein the plasma is formed by a microwave.
